(19) United States
(12) Patent Application Publication
(10) Pub. No.: US 2008/0148346 A1
(43) Pub. Date: Jun. 19, 2008

(54) COMPLIANCE CONTROL SYSTEM

(76) Inventors: Ravinder Gill, Fremont, CA (US); Lee Cooper, San Francisco, CA (US); Paul Young, Monument, CO (US); Pankaj Srivastava, Belmont, CA (US); Boulos Aoun, San Jose, CA (US)

Correspondence Address: SCHWEGMAN, LUNDBERG & WOESSNER/SAP, P.O. BOX 2938, MINNEAPOLIS, MN, 55402, US

(21) Appl. No.: 11/855,914

(22) Filed: Sep. 14, 2007

Related U.S. Application Data
(60) Provisional application No. 60/875,024, filed on Dec. 15, 2006.

(51) Int. Cl. H04L 9/00

(52) U.S. Cl. 726/1

(57) ABSTRACT

A method comprises automatically obtaining network data, and automatically processing the network data to detect violation of a compliance control policy of an entity.

### CLAIM OF PRIORITY

The present patent application claims the priority benefit of the filing date of U.S. provisional application No. 60/875,024 filed Dec. 15, 2006, the entire content of which is incorporated herein by reference.

### FIELD

This application relates to example methods and systems to perform automated compliance control systems and processes.

### BACKGROUND

Enterprise resource planning (ERP) systems are management information systems that integrate, automate, track, and regulate many business practices of a company. ERP systems can address many facets of a company's operation, such as accounting, sales, invoicing, manufacturing, logistics, distribution, inventory management, production, shipping, quality control, information technology, and human resources management. ERP systems can include computer security to protect against outside crime such as industrial espionage, and to protect against inside crime such as embezzlement. ERP systems can be set up to detect, prevent, and report a variety of different occurrences of fraud, error, or abuse. ERP systems can be oriented to the company's interactions with customers (“front end” activities), quality control and other internal workings of the company (“back end” activities), interactions with suppliers and transportation providers (“supply chain”), or other aspects of business.

It is becoming increasingly beneficial for companies to supplement ERP systems with compliance control applications in view of recent laws such as “The Sarbanes-Oxley Act of 2002” (Pub. L. No. 107-204, 116 Stat. 745, Jul. 30, 2002), also known as “Sarbanes-Oxley” or the “Public Company Accounting Reform and Investor Protection Act of 2002” or “SOX.” Sarbanes-Oxley seeks to protect investors by improving the accuracy and reliability of corporate disclosures. The act covers issues such as establishing a public company accounting oversight board, auditor independence, corporate responsibility, and enhanced financial disclosure.

Among other things, Sarbanes-Oxley requires CEOs and CFOs to certify financial reports. Moreover, Sarbanes-Oxley mandates a set of internal procedures designed to ensure accurate financial disclosure.

Although modern ERP systems help companies become better organized and some even address the challenges of regulatory requirements such as Sarbanes-Oxley, operating, administering, or modifying an ERP system can be exceedingly complex. Indeed, because of their wide scope of application within a company, ERP software systems rely on some of the largest bodies of software ever written. Additionally, a number of technical challenges are presented by the wide variety of sources from which information must be collected in order to perform effective compliance control.

### BRIEF DESCRIPTION OF DRAWINGS

Some embodiments are illustrated by way of example and not limitation in the figures of the accompanying drawings in which:

FIG. 1 is a block diagram illustrating a compliance control system, according to an example embodiment, that includes a compliance manager communicatively coupled to a number of business application systems and one or more network systems.

FIG. 2 is a block diagram presenting an alternative, and more detailed view, of the architecture of a compliance control system, according to an example embodiment.

FIG. 3 is an entity relationship diagram showing relationships between various data structures that may be maintained within the compliance repository.

FIG. 4 is a flowchart illustrating a method, according to an example embodiment, to define a compliance control data structure.

FIG. 5 is a flowchart illustrating a method, according to an example embodiment, to detect a violation of a compliance control policy utilizing network data.

FIG. 6 is a block diagram illustrating architecture of an example implementation of a compliance control system, specifically for the monitoring of controls related to Service Level Agreements (SLAs).

FIGS. 7-9 are swim lane diagrams illustrating a process flow 700, according to an example embodiment, through the architecture of FIG. 6.

FIG. 10 is a block diagram of machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

ERP monitoring solutions often assess risk “after-the-fact” through the use of detection solutions that operate on downloaded data. For a large enterprise, downloading can take hours. By the time the download and analysis are complete, new users, new role assignments, and new transactions have already altered the system. Any corrective work may fail to eliminate the conflict, since it would be executed on an already-changed system. And, whether the corrective work succeeded would not be known until another download and analysis can be completed. There is significant potential for cascading negative effects.

Moreover, since constant downloading depletes information technology (IT) and system resources, few advocates of after-the-fact monitoring execute a controls analysis more frequently than daily or weekly. Depending on the frequency of downloading and analysis, violations could persist for a considerable length of time before being discovered. By the time risk is assessed in this manner, the damage might already be done. In this respect, some conventional solutions expend considerable computing resources to assess risk, yet still are not fast enough.

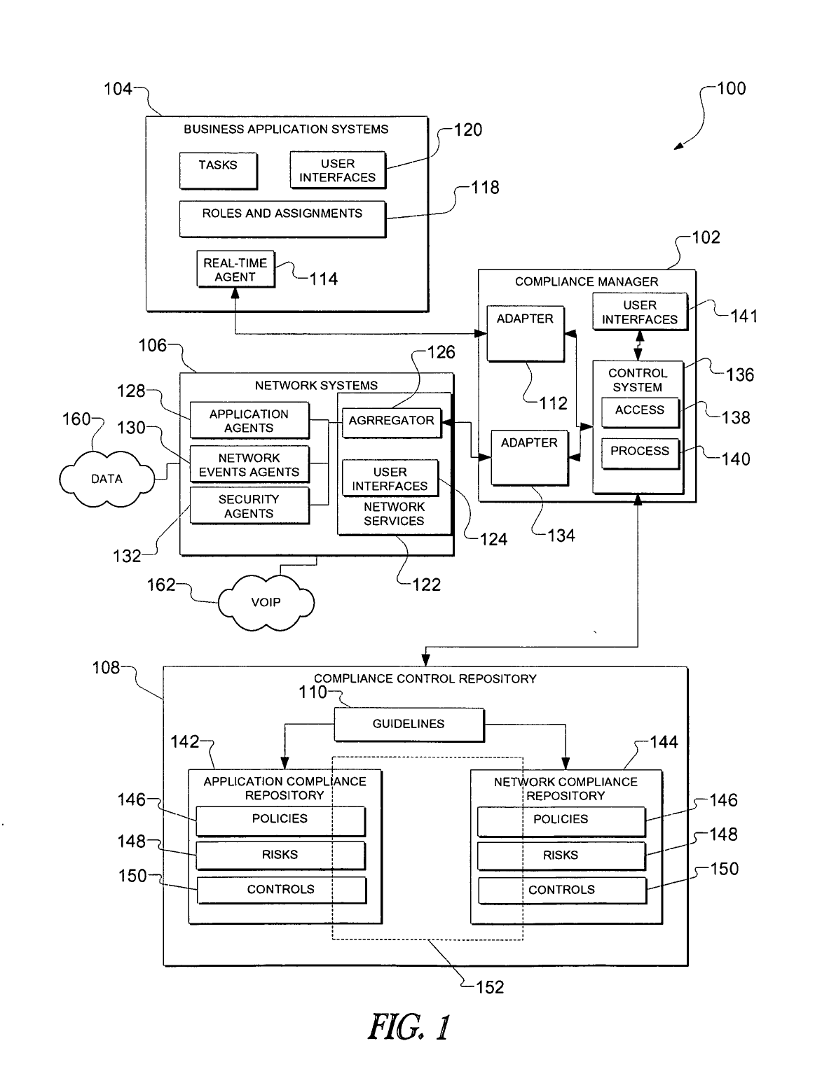

FIG. 1 is a block diagram illustrating a compliance control system 100, according to an example embodiment, that includes a compliance manager 102 communicatively coupled to a number of business application systems 104 and one or more network systems 106. The compliance manager 102 is also communicatively coupled to a compliance control repository 108. The above described components may be implemented by one or more hardware devices, software modules or components, a portion of a hardware device and a software module or component, or a combination of the foregoing. Further, the components 102-108 may be operated on behalf of an entity, such as a company, partnership, joint venture, corporate subdivision, government unit, family, non-profit, individual, trust, or other organization. The system 100 may be used by an operating entity to carry out, for example, various business activities under the direction of its users via respective user interfaces.

The compliance control manager 102, at a high level, operates to guide, regulate and control actions of the system 100 to promote compliance with (e.g., by detecting violations of) certain company guidelines 110, which may be stored electronically within the compliance control repository 108. The guidelines 110 may be embodied by one or more sets of company policies, government regulations, penal law, accounting rules, good business practices, conditions (e.g., imposed by a charter, articles of incorporation, grant of money, requirements of non-profit status, etc.), or a combination of the foregoing.

The compliance manager 102 is shown to be coupled to both the business application systems 104 and network systems 106 in order to extract information from these systems, this information then being analyzed to detect risks of violations of the guidelines 110 as reflected both in application data (e.g., as extracted from the business application systems 104) and network data (e.g., as extracted from the network systems 106). To this end, the compliance manager 102 is shown to include an adaptor 112 which collects application data (e.g., via a network) from one or more real-time agents 114 that may be embedded within, or associated with, multiple business application systems 104. High level operations that may be performed by the compliance manager 102 include risk detection, simulation, mitigation, remediation, reporting etc. It will of course be appreciated that multiple business application systems 104 may not necessarily be compatible with each other (e.g., as a result of employing different software architectures and/or as having been supplied by different business application vendors). Accordingly, business application system specific real-time agents 114 may be associated with various proprietary business application systems, each of these real-time agents 114 communicating application data back to the adaptor 112. The adaptor 112 may then operate to aggregate, normalize and/or filter application data received from the various real-time agents 114.

Some examples of business application systems 104 may include Enterprise Resource Planning (ERP) subsystems supplied by SAP A.G., Oracle Corporation, Microsoft Business Division and Ramco Systems, merely for example. Each of the business application systems 104 may furthermore include respective tasks 116 that are performed by the business application systems 104, roles and assignments which define task allocations within the business application systems 104 and user interfaces 120, via which users may interact with the business application systems 104.

Turning now to the network systems 106, it will be appreciated that certain data that may be useful to the compliance manager 102 in enforcing the guidelines 110 may not necessarily reside at an application-layer, but could also reside within network data. Indeed, to most effectively enforce guidelines 110, it may be useful for the compliance manager 102 to have a view of both application data and network data, and to utilize various combinations and permutations of this data. Of course, some compliance operations performed by the manager 102 may look exclusively at application data, or exclusively at network data. Examples of network data may include network traffic data (e.g., data extracted from actual network traffic traversing a network), network events (e.g., events on a network that may be detected by various network monitoring systems), a network security data (e.g., intrusion data generated by firewall systems), and Service Level Agreement (SLA) compliance data (e.g., data relating to service levels provided by Information Technology (IT) resources responsive to network requests for service).

In order to collect the network data, the network systems 106 are shown to include a network services system 122 (e.g., the Cisco Service-Oriented Network Architecture (SONA) framework), which may present a number of user interfaces to an operator or user, and also includes an aggregator 126. The aggregator 126 is in turn coupled to one or more application agents 128, network agents 130 and security agents 132 that operate to collect the network information mentioned above, and communicate this network information to the aggregator 126, which may perform various aggregation and filtering operations. The aggregator 126 then, via appropriate interfaces, communicates the aggregator and filtered network data to an adaptor 134 of the compliance manager 102.

Each of the adaptors 112 and 134 feeds respective application data and network data through to a control system 136, which includes both access control components 138 and process control components 140 to respectively ensure compliance with the guidelines 110 by permitting and restricting access (e.g., utilizing the access control component 138), and controlling (e.g., permitting or denying) execution of processes (e.g., utilizing the process control component 140). The control system 136 is also communicatively coupled to one or more user interfaces 141 via which an operator of the control system 136 can provide input to, and receive output from, the control system 136.

Turning now to the compliance repository, the guidelines 110 may be realized through data stored within an application compliance repository 142 and a network compliance repository 144. As shown, each of the repositories 142 and 144 stores appropriate policies 146, risks 148 and controls 150. As shown in broken line at 152, certain policies 146, risks 148 and controls 150 may straddle both the application and network, and accordingly reside in both of these domains. Polices 146, in one embodiment, may be realized as a collection of rules against which gathered application data and/or network data may be applied to detect any violations of the policies. Risks 148 may specify risks associated with various detected combinations, or combinations of violations. For example, certain violations may pose a much higher degree of risk to an entity than other violations. Similarly, various combinations of violations may be indicative of a higher risk exposure to the entity than other violation combinations. Finally, controls 150 specify actions to be taken responsive to policy violations. Controls may be made contingent upon risk levels described in the risks 148.

The control system 136 accordingly accesses the compliance control repository 108, with a view to retrieving policies 146, risks 148 and controls 150, and operationally applying this guideline information against the application data, for example received via the adaptor 112, and the network data, for example received via the adaptor 134, using the access control component 138 and the process control component 140. The use of the network data, either alone, or in combination with the application data, enables the control system 136 to implement controls at a very “deep” level. Further, in view of the access by the control system 136 to network data, it will be appreciated that guidelines 110 may be specified to penetrate deeper into activities and processes that are performed on the infrastructure resources of the relevant entity controlling the compliance system 100.

It will also be noted that the network systems 106 may be coupled to various networks including data networks 160, and communications networks 162 (e.g., a Voice over Internet Protocol (VoIP) network, a Public Switched Telephone Network (PSTN), or various other networks.

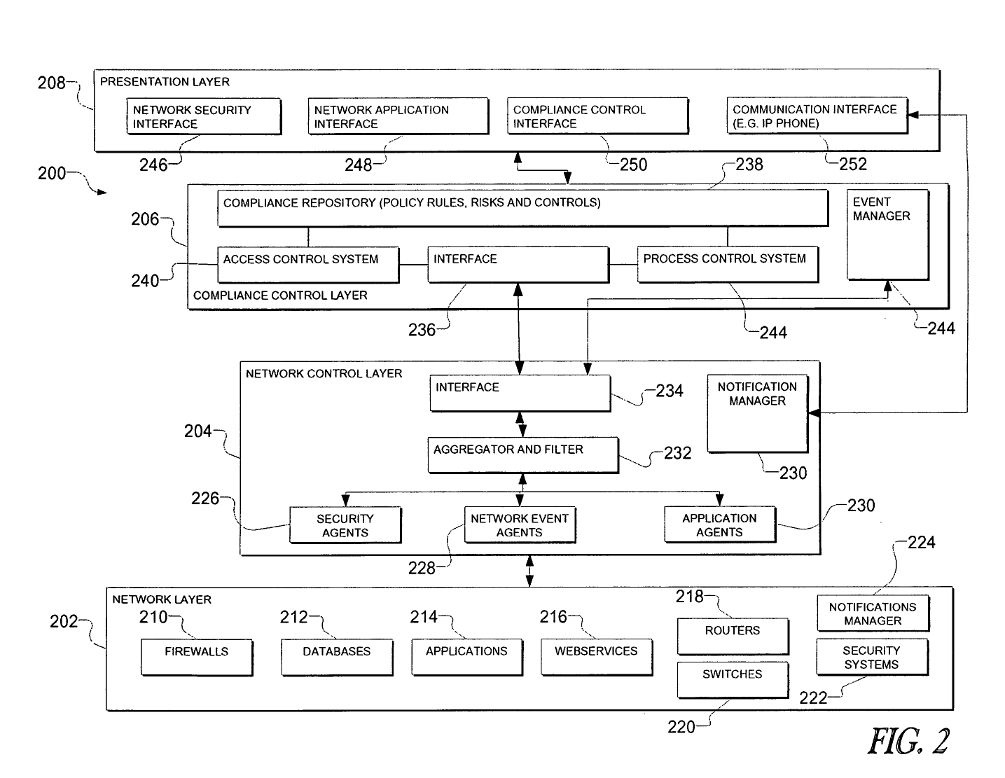

FIG. 2 is a block diagram presenting an alternative, and more detailed view, of the architecture of a compliance control system 200, according to an example embodiment. The depiction shown in FIG. 2 is a layer depiction. Components of the compliance control system 200 may conceptually be viewed as residing either at a network layer 202, a network control layer 204, a compliance control layer 206 or a presentation layer 208. Dealing specifically with the network layer 202, this layer is shown to include a number of network-layer components including firewalls 210, databases 212, network applications 214, web services 216, routers 218, switches 220, network security systems 222 (e.g., intrusion detection systems), and a notification manager 224.

Turning now to the network control layer 204 (e.g., Cisco SONA technology), a collection of agents, including security agents 226, network agents 228 and applications agents 230 collect network data from the various components of the network layer. In various example embodiments, the application agents 230 may comprise the CS-MARS Appliance developed by Cisco Systems, Inc. and/or the Application-Oriented Network (AON) technology, again sold by Cisco Systems, Inc. The security agents 226 and network agents 228 may similarly comprise components of the CS-MARS Appliance. One or more security agents 226 may subscribe to, information published by, or otherwise receive information from, any one of the security systems 222 and firewalls 210. Similarly, network agents 228 may monitor network traffic across various routers 218 and switches 220 to extract data useful for enforcing data privacy policies. For example, the network agents 228 may extract traffic data traversing routers 218 and switches 220 that may include social security numbers. The network agents 228 may also examine network traffic traversing the routers 218 and switches 220 to detect data patterns, which may be specified in terms of various policy rules. Finally, the application agents 230 may monitor various parameters and events occurring with respect to the network databases 212 and network applications 214.

An aggregator and filter component 232 is communicatively coupled to each of the agents 226, 228 and 230, and may operatively aggregate and filter the network data received from these agents. Specifically, the aggregator and filter component 232 may attempt to detect information that is indicative of a false positive, and filter such false positive information from the network data received from the agents. Similarly, any one of a number of aggregation functions may be performed, including the removal of redundant or duplicate data instances from the data received from the agents 226-230.

The aggregator and filter component 232 is in turn coupled to an interface 234, which enables communications between the network control layer 204 and the compliance control layer 206. In an example embodiment, the interface may be an event interface developed as part of the AON technology.

The compliance control layer 206 similarly includes an interface 236 which is adapted to communicate with the interface 234 of the network control layer 204. In an example embodiment, the interface 236 may be an adaptor, such as that described at reference 134 with reference to FIG. 1, and may be a custom interface specifically to enable communications with the network control layer 204.

The compliance control layer 206 further includes a compliance repository 238 (an example of which was described with reference to FIG. 1), an access control system 240, which operatively controls access events with respect to components of the system 200, and a process control system 242, which operatively controls processes implemented and executed within the system 200. The compliance control layer 206 also includes an event manager 244 which, in an example embodiment, may be utilized for SLA monitoring, and allows for the definition of escalation paths in the event that a violation of a rule, forming part of an SLA policy, is detected.

The presentation layer 208 may include interfaces to a number of the components described above as residing in the layers 202-206. Specifically, a network security interface 246 may enable an entity to interface with one or more security agents 226, a network application interface 248 enables user interfacing with a network agent 228 or an application agent 230, a compliance control interface 250 enables user interface with various components in the compliance control manager and the communication interface 252 (e.g., an IP phone) interfaces with the notification manager 235 of the network control layer.

Operations of the system 200 will be described below with reference to further figures. However, it will be noted that the communications between the layers is bidirectional. Within the compliance control layer 206, policy rules, risks and controls maintained within the compliance repository 238 may be communicated, via the access control system 240, the process control system 242, and the interface 236 down to the network control layer 204. The interfaces 236 and 234 may operate to translate (or map) the policy rules that may be implemented by any one or more of the agents 226-230. Accordingly, there is a translation or mapping of the policy rules, as maintained within the repository 238, into data capture instructions that may be utilized by the agents 226-230 to capture information needed to give effect to the various rules. Similarly, network data, gathered by the agents 226-230 is communicated upwards, via the interfaces 234 and 236 to the access control system 240 and the process control system 242 which operate to implement the policy rules, risks and controls based on, at least partially, the network data received from the network control layer 204.

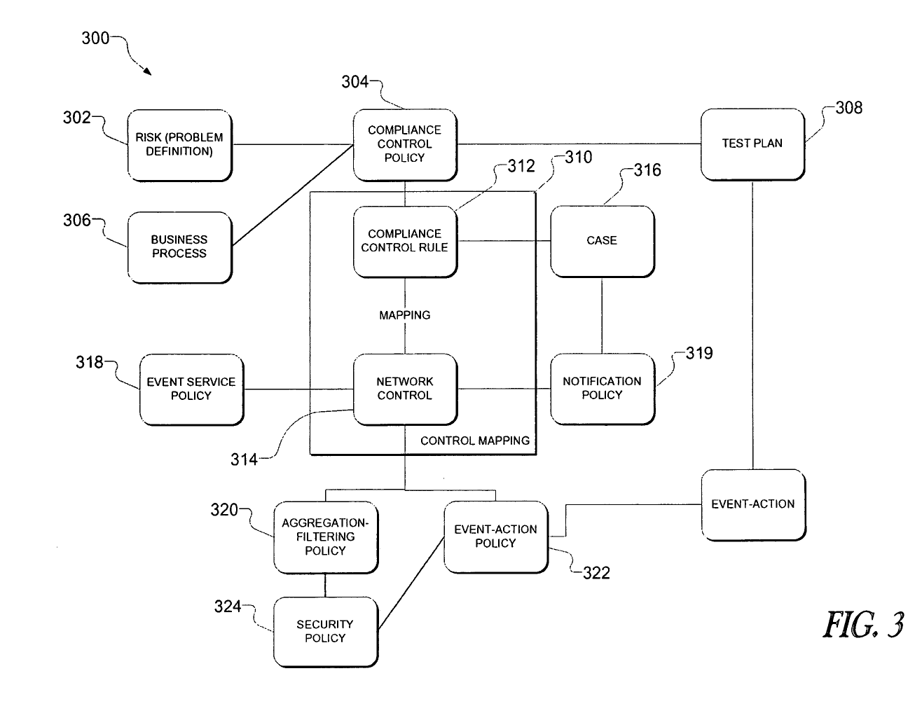

FIG. 3 is an entity relationship diagram showing relationships between various data structures that may be maintained within the compliance repository 238. The data structures 300 include risk specification 302 (e.g., a problem definition) which may find expression in one or more compliance control policies 304. For example, for an electronic payments company, the risk may be specified to be a data privacy violation (e.g., social security numbers and other sensitive information regarding customers may need to be rigorously protected). This risk may be subject to multiple compliance control policies 304. Each compliance control policy 304 may furthermore impact a business process 306. For example, a compliance control policy 304 may be associated with, and implemented within the context of, a particular business process, such as authorizing an online payment utilizing the secure customer information, such as a social security number.

Each compliance control policy 304 may be associated with a respective test plan 308 that enables testing of the compliance control 304.

A control mapping 310 facilitates a mapping between a compliance control rule 312 and a network control 314 (e.g., a SONA control). Specifically, a compliance control 312 may be expressed at a higher level than a corresponding network control 314. Further, a compliance control rule 312 may examine a wider data set than purely network data, and may also consider application and other data. In one example embodiment, the compliance control 312 may be instantiated by one or more network controls. For example, a single network control may be configured as a subset of the compliance control rules 312. In another embodiment, the compliance control 312 may be instantiated or implemented by the network control 314.

Accordingly, the mapping between the compliance control rules 312 and the network control rules 314 may operate to effectively translate a compliance control rule 312 to a network control 314 that is capable of interpretation by, for example, the various agents 226-230. It will be noted that, in one example embodiment, the network control rules 314 may be “detective,” as well as “preventive” in nature. For example a rule from the network control rules 314 may be configured to detect a violation. In another example, some rules from the network control rules 314 may be configured (e.g., through the event service policy 314) to stop or prevent an event or an action from occurring or being performed. In one example embodiment, the network data or a network event may follow the same flow regardless of whether a rule that is being applied is detective or preventive.

In the event of a violation of a compliance control rule 312, a case 316 may be instantiated to log and record information in connection with that violation. Similarly, a notification policy 319 may be associated with a network control 314 in order to enable various notifications to be generated in the event of a violation of the network control 314.

A number of policies may also be associated with each network control 314. Specifically, multiple event-service policies 318 may be associated with each network control 314, each event-service policy 318 specifying requirements for a service event. An example of a service event is a service that has been requested from an IT department, for example, within a corporation. In the event that such a service is not delivered within a predetermined time, or at least some steps taken to initiate delivery of that service, a violation of the relevant event-service policy 318 may be registered by the network control 314.

Similarly, multiple aggregation-filtering policies 320 may be associated with each network control 314, and utilized by the aggregator and filter component 232, described above with reference to FIG. 2, to aggregate and filter network information received from the agents 226-230. Multiple event-action policies 322 associated with the network control 314 may be implemented by one or more network event agents 228 in order to detect predetermined network events. For example, a social security number that is being communicated across the network may be blocked or stopped by a preventive rule from the network control rules 314 when an event-action policy is being applied.

Similarly, a security policy 324 may be utilized by one or more security agents 226 to monitor predetermined security events (e.g., intrusions) with respect to a network

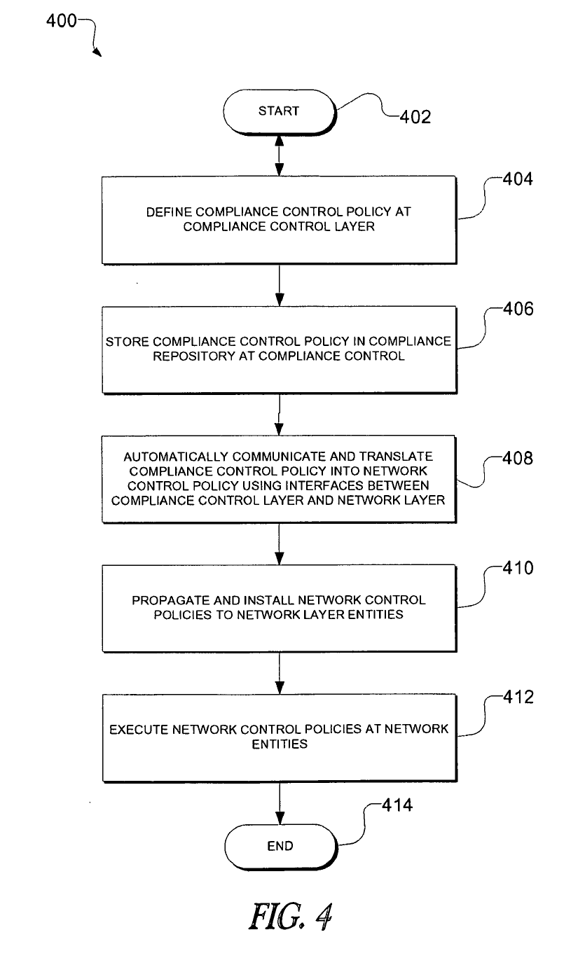

FIG. 4 is a flowchart illustrating a method 400, according to an example embodiment, to define a compliance control data structure, such as that shown at 300 in FIG. 3.

The method 400 commences at operation 402, and progresses to operation 404 with the receipt of a definition of a compliance control policy 304, at the compliance control layer 206. For example, the definition of the compliance control policy with 304 may be received via the compliance control interface 250 of the presentation layer 208, or may alternatively be uploaded from some other source. In various example embodiments, the compliance control policy 304 may be a company policy, a government regulation, a law, a professional rule, an accounting rule, a statement of good business practices, a condition imposed by a contract, or a corporate article.

At operation 406, the compliance control policy 304 is stored in the compliance repository 238 at the compliance control layer.

At operation 408, the compliance control policy 304 is automatically communicated and translated into one or more network control policies, utilizing the interfaces 236 and 234 between the compliance control layer 206 and the network control layer 204. Specifically, the control mapping 310 (described above with reference to FIG. 3) may be utilized to relate the compliance control policy 304 to one or more network control policies, such as the event-service policy 318, the aggregation-filtering policy 320, the event-action policy 322 or the security policy 324. In one example embodiment, compliance control policy 304 may be expressed in business terms, e.g., a policy to protect customer's private information. The network control rules 314 may be expressed in technical terms, e.g., a rule to detect and to stop network traffic including social security data.

At operation 410, the network control policies are installed at the network layer entities. For example, the various policies described above in 318-324 may be installed at agents 226-230.

At operation 412, the network control policies are then executed at the relevant network entities, hereafter the method 400 terminates at operation 414.

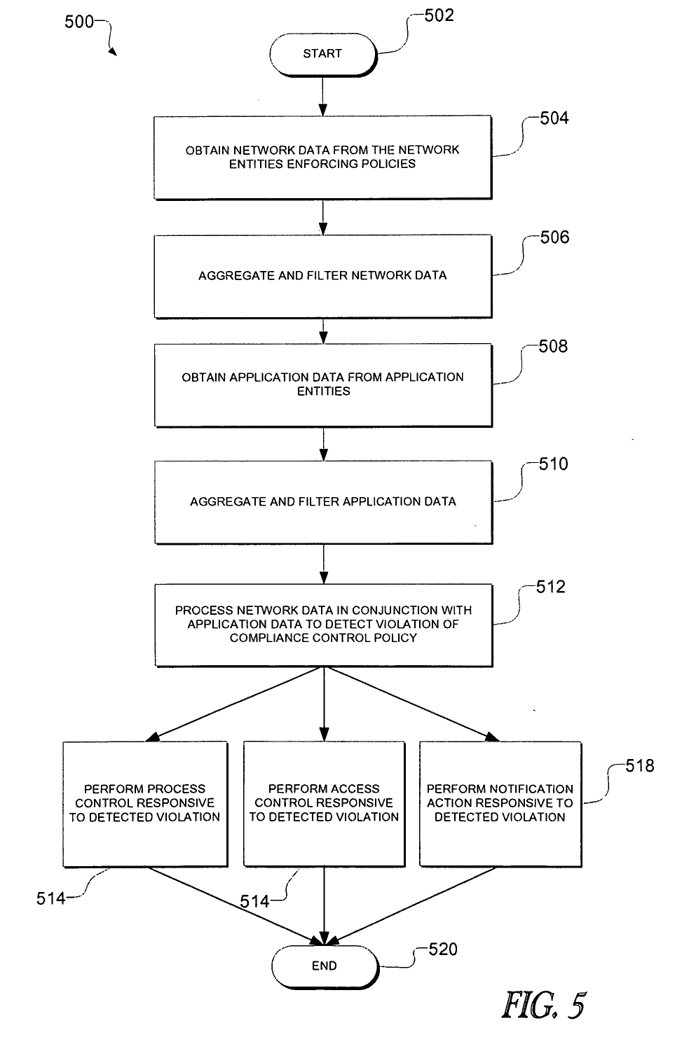

FIG. 5 is a flowchart illustrating a method 500, according to an example embodiment, to detect a violation of a compliance control policy utilizing network data. The method 500 commences at operation 502, and progresses to operation 504 with the obtaining of network data from various network layer entities (e.g., the entities 210-224) by the various agents 226-230 enforcing various network control policies (e.g., the policies 318-322). The agents 226-230 may, for example, subscribe to data feeds from the various network layer entities 210-224 using a published-subscribed system, or may access various interfaces provided by the entities 210-224 to obtain this network information.

At operation 506, the network data is aggregated and filtered, for example via the aggregator and filter component 232, utilizing the aggregation-filtering policy 320.

At operation 508, application data may be obtained from various applications (e.g., the business application systems 104 described with reference to FIG. 1). The application data may be obtained, for example, utilizing real-time agents 114 that are embedded with, or otherwise in communication with, respective business application systems 104.

At operation 510, the obtained application data may also be aggregated and filtered in the manner similar to the way in which the network data was aggregated and filtered at operation 506.

At operation 512, the network data is processed, in conjunction with the application data, to detect violations of compliance control policies. It will be appreciated that violation of a compliance control policy 304, as embodied in a security policy 324, may be detected utilizing only the network data. However, as described above with reference to 152, certain policies may span both application and network compliance policies, risks and controls, The network data, obtained at operation 504 and the application data obtained at operation 508, may be used cooperatively and in conjunction to detect the violations of certain compliance control policies at operation 512.

The obtaining of the network data at operation 506 may include monitoring network traffic data using any one of the agents 226-230, and the processing of the network data may include processing to obtain network traffic data to detect, for example, a data privacy violation. A rule to detect data privacy violation, in one embodiment, is an example of a “preventive” control that may be configured to stop private data from being communicated via the network. In another example embodiment, the obtaining of the network data may include monitoring network events, for example utilizing the network event agent 228, then the processing of the network data at operation 512 may include processing of this network event data to detect certain events which may be indicative of a violation of an event-service policy 318 or an event-action policy 322. In yet another embodiment, the obtaining of the network data at operation 504 may include using an application agent 230, for example, to obtain Service Level Agreement (SLA) compliance data, and the processing of the network data may include processing the SLA compliance data to detect an SLA violation of an SLA policy 326.

Moving on to operation 514, responsive to a detection of a violation of a compliance control policy 304, the compliance control system 200 may perform a process control, responsive to this detected violation to, for example, prevent the occurrence of a certain event. For example, the process control may be performed by the process control system 242.

At operation 516, the compliance control system 200 may also perform an access control, responsive to the detected violation. In an example embodiment, this access control may be performed by the access control system 240.

Further, at operation 518, the compliance control system may also perform a notification action, responsive to the detected violation. For example, the notification manager 235 may, responsive to a detection of a violation, provide a suitable alert communication to a communication interface 252 (e.g., send a notification to an IP phone of a designated respondee to a particular type of violation). The method 500 then terminates at operation 520.

A number of example use scenarios of the technology described above will now be provided. Considering a deployment in which the compliance control system 200 primarily concerned with network IT security issues, it should be noted that the agents 226-230 may collect network data reflecting various types of violations, including Denial of Service (DoS) attacks, firewall policy violations, unauthorized changes to firewall, and router or switch configurations. Example violations of the various rules may also be built on information relating to object accesses, security posture, validation/status, successful logins, suspicious files, uncommon traffic, penetration attempts (e.g. into systems using buffer flow, overflow attack). Network security policies 324 may be configured to detect the above, and may be enforced, for example, by various network security agents 226.

Within a network IT security use scenario, both continuous monitoring and periodic testing for policy violations may be applied. In the case where periodic testing is applied, a test plan 308, as shown in FIG. 3, may be associated with a compliance control policy 304.

Considering first an example scenario in which continuous monitoring of network security is required, a global enterprise may, for example, open up a set of branch offices or store fronts in a new region which is less physically secure than a main office, and may be concerned about exposing the network infrastructure of the entity to security breaches via such branch offices. In this scenario, a number of the branch offices may each be coupled via a network connection to primary network resources, and may also be provided with firewall protection. An operations supervisor may in this scenario have access to a communication interface 252 (e.g., an IP phone), while a network administrator may for example have access, via a network security interface 246, to components of the network control layer 204.

The network control agents 226-230 may be configured to detect three kinds of network events, and map such events to appropriate compliance control rules 312, implemented within the compliance control layer 206. Examples of these network events may be unauthorized firewall configuration changes, firewall policy violations, and network penetration attempts. In the event that any of the agents 226-230 detect, utilizing appropriate security policies 324 for example, any one of the events occurring in one of the new regions, this network data is communicated to the aggregator and filter component 232, which then normalizes the event data, and interfaces, via the interfaces 234 and 236, with the compliance control layer 206.

The controller (e.g., the process control system 242) may then evaluate the event against the appropriate policy, and initiate a remediation process. The remediation process may include instructing the compliance control layer 206 to notify a regional supervisor by an alert to the communication interface 252 (e.g., IP phone). The compliance control layer 206 may then issue a broadcast, depending on the severity of the control violation. The remediation process may also involve sending an alert to a regional network administrator, through the control compliance layer 206, to review various reports available and pushed through, by the compliance control layer 206, to an appropriate interface in the presentation layer 208.

The network administrator then may review the appropriate reports (e.g., on a network security interface 246), and apply appropriate fixes through standard network based practices.

Considering now the periodic testing use scenario, the compliance control layer 206 (e.g., the process control system 242) may send through a notification to a regional network administrator to run tests on compliance control policies 304, and certify them. Example controls may include unauthorized firewall access, firewall policy violations, or penetration attack preventions. The network administrator for a particular region then logs into the control system 136, for example, using an appropriate interface in the presentation layer 208, and follows a standard test plan as a checklist of steps. As part of the test plan, the network administrator may be asked to run an historical report. The test owner may then evaluate and document the results of these tests. For example, where there is a test failure, the test owner may initiate a new remediation flow from the compliance control layer 206. Where the test is a success, the test owner may close the testing flow.

In a data privacy use scenario, continuous monitoring may be utilized to detect the unauthorized transmission of social security numbers, credit card numbers, etc. In this case, various network policies may be implemented to perform pattern matching against a policy. Other examples of privacy data that may be monitored include the transmission of competitive pricelists, or communications regarding illegal gifts.

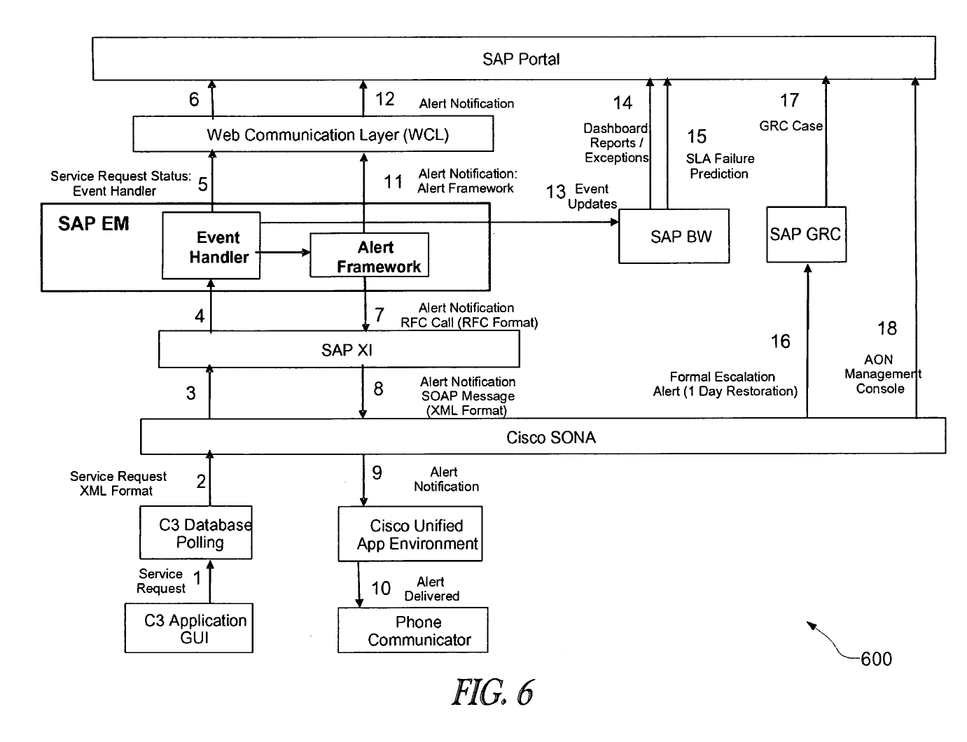

FIG. 6 is a block diagram illustrating architecture of an example implementation of a compliance control system 600, specifically for the monitoring of controls related to Service Level Agreements (SLAs). The example deployment utilizes Cisco SONA (Service Oriented Network Architecture) technology to implement the network control layer 204, and utilizes SAP Government, Risk and Compliance (GRC) technology to implement an example compliance control layer 206. As shown, at 601, a service request is received from a user, via an application Gooey. For example, the service request may be with respect to an IT service that the user needs delivered.

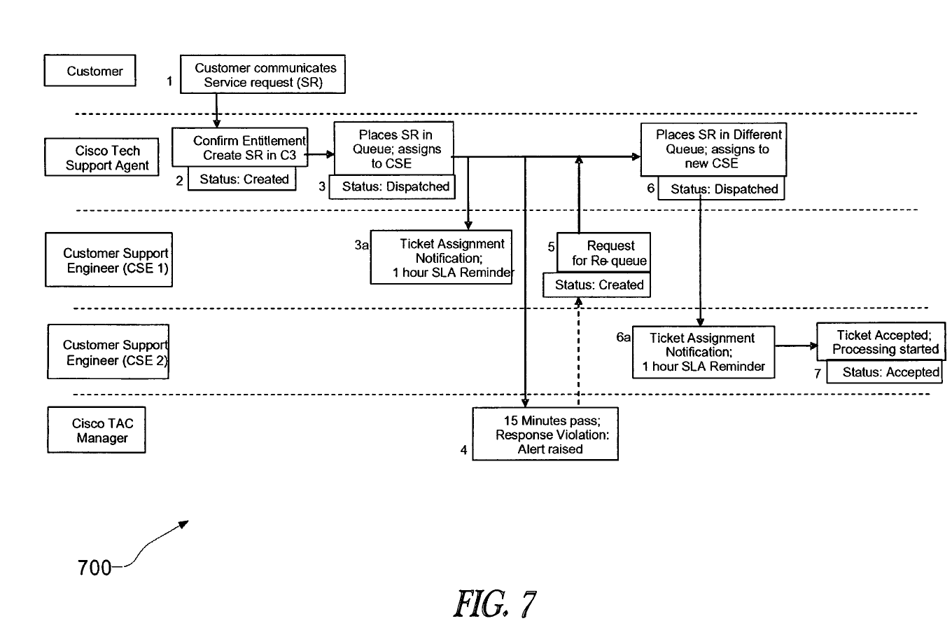

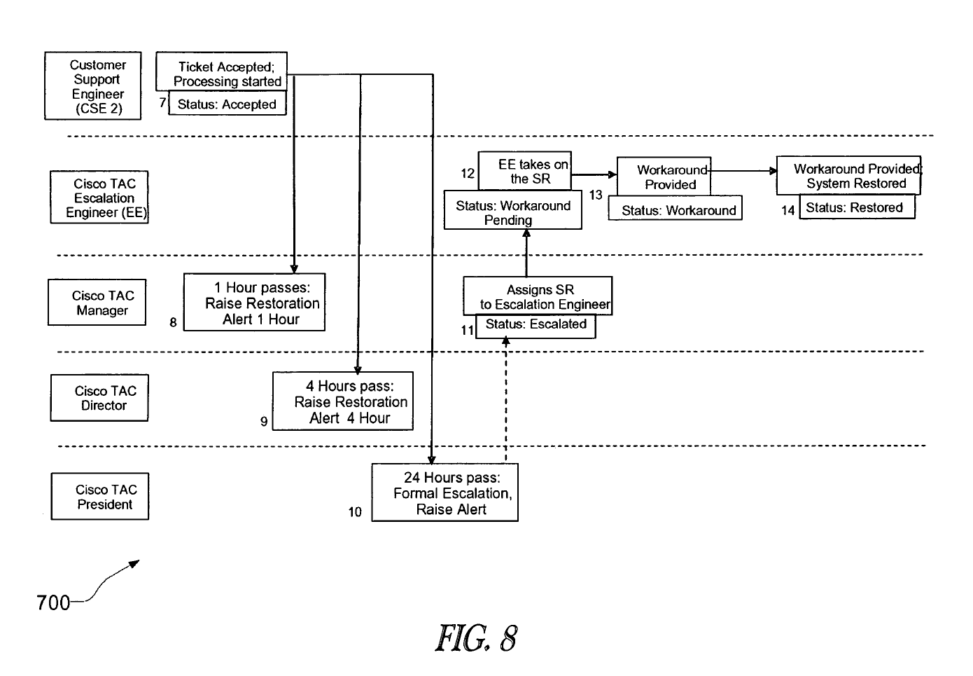

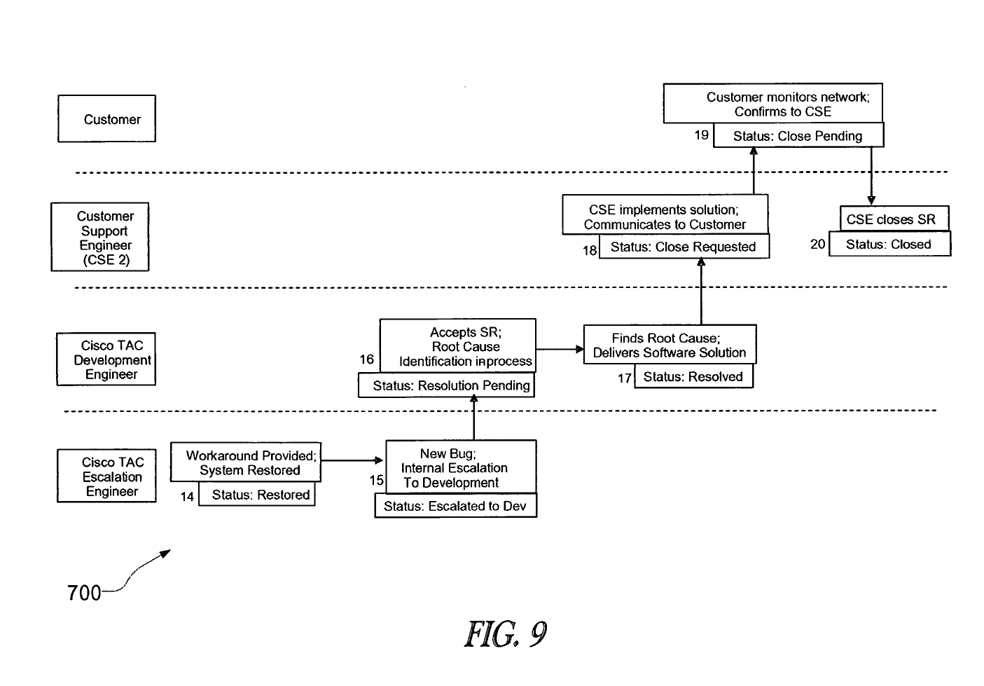

A process flow 700, according to an example embodiment, through the architecture 600 is illustrated in FIGS. 7-9. The entities and operations involved in this process 700 are apparent from the swim lane diagrams presented in FIGS. 7-9.

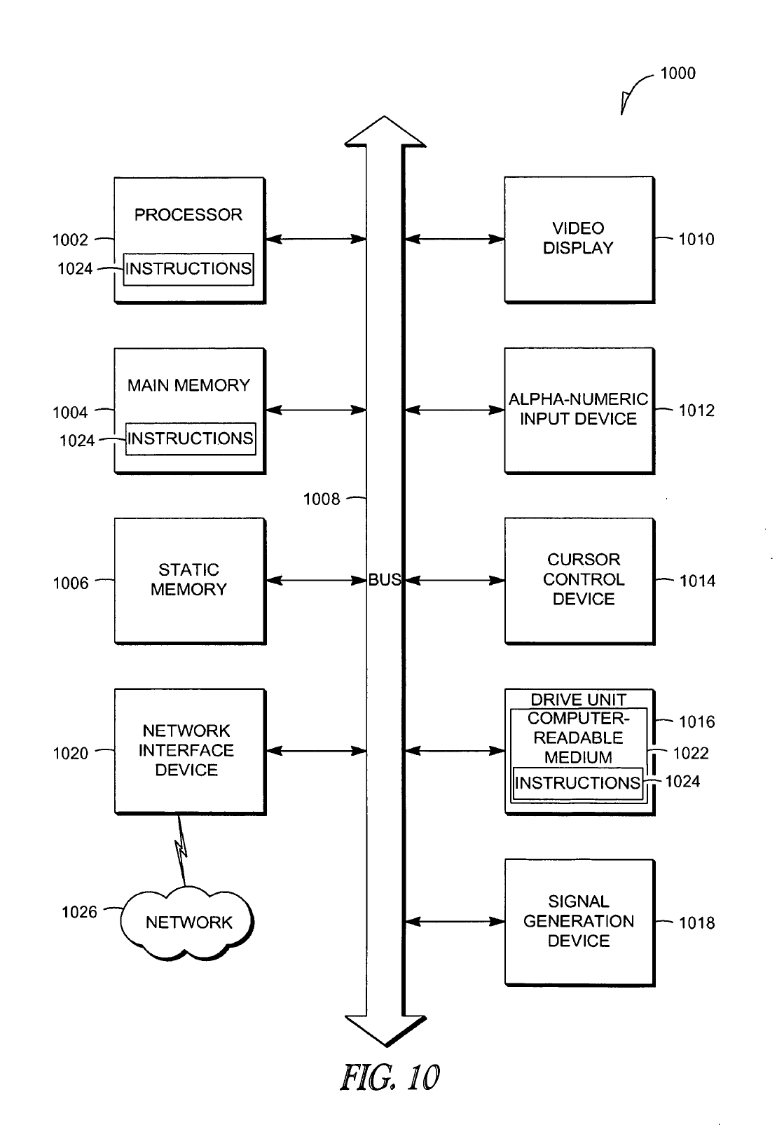

FIG. 10 is a block diagram of machine in the example form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020 utilizing any one of a number of well-known transfer protocols (e.g., HTTP).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method operations of the invention can be performed by one or more programmable processors executing a computer program to perform functions of the invention by operating on input data and generating output. Method operations can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

The invention can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information).

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

While the foregoing disclosure shows a number of illustrative embodiments, it will be apparent to those skilled in the art that various changes and modifications can be made herein without departing from the scope of the invention as defined by the appended claims. Accordingly, the disclosed embodiment are representative of the subject matter which is broadly contemplated by the present invention, and the scope of the present invention fully encompasses other embodiments which may become obvious to those skilled in the art, and that the scope of the present invention is accordingly to be limited by nothing other than the appended claims.

In addition, those of ordinary skill in the relevant art will understand that information and signals may be represented using a variety of different technologies and techniques. For example, any data, instructions, commands, information, signals, bits, symbols, and chips referenced herein may be represented by voltages, currents, electromagnetic waves, magnetic fields or particles, optical fields or particles, other items, or a combination of the foregoing.

Moreover, ordinarily skilled artisans will appreciate that any illustrative logical blocks, modules, circuits, and process operations described herein may be implemented as electronic hardware, computer software, or combinations of both.

To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
automatically obtaining network data; and
automatically processing the network data to detect a violation of a compliance control policy of an entity.

2. The method of claim 1, including automatically obtaining application data, and automatically processing the application data in conjunction with the network data to detect the violation of the compliance control policy of the entity.

3. The method of claim 1, wherein the compliance control policy is at least one of a company policy, a government regulation, a law, a professional rule, an accounting rule, a statement of good business practices, a condition imposed by a contract, or a corporate article.

4. The method of claim 1, wherein the obtaining of the network data includes monitoring network traffic data, and wherein the processing of the network data includes processing the network traffic data to detect a data privacy violation.

5. The method of claim 1, wherein the obtaining of network data includes monitoring network events to obtain network event data, and wherein the processing of the network data includes processing the network event data.

6. The method of claim 1, wherein the obtaining of the network data includes obtaining network security data, and wherein the processing of the network data includes processing the network security data to detect a network security violation.

7. The method of claim 1, wherein the obtaining of the network data includes obtaining service level agreement (SLA) compliance data, and wherein the processing of the network data includes processing the SLA compliance data to detect an SLA violation.

8. The method of claim 1, including:
defining the compliance control policy at a compliance control system;
storing the compliance control policy within a policy repository;
communicating the compliance control policy from the compliance control system to a network service application, the network service application to utilize the compliance control policy in the obtaining of the network data;
automatically translating the compliance control policy into at least one network control policy; and
installing the at least one network policy at the network service application.

9. The method of claim 8, wherein the network service application is to
obtain the network data from a plurality of network entities, and is to aggregate to the network data; and
filter the network data obtained from the plurality of network entities,
and wherein the plurality of network entities include at least one of network devices, network applications, or network Web services.

10. The method of claim 1, including performing process control responsive to the detection of the violation of the compliance control policy of the entity, the performance of the process control including preventing occurrence of an event and performing a remedial action to remedy the violation of the compliance control policy.

11. The method of claim 1, including performing access control responsive to the detection of the violation of the compliance control policy of the entity, and wherein the performance of the access control includes restricting access to at least one of a network-layer process and an application-layer process.

12. The method of claim 1, including performing a notification action responsive to the detection of violation of the compliance control policy of the entity.

13. A system comprising:
a network system to automatically obtain network data; and
a compliance control system to process the network data to detect a violation of a compliance control policy of an entity.

14. The system of claim 13, wherein the compliance control system is to obtain application data, and is automatically to process the application data in conjunction with the network data to detect the violation of the compliance control policy of the entity.

15. The system of claim 13, wherein the compliance control policy is at least one of a company policy, a government regulation, a law, a professional rule, an accounting rule, a statement of good business practices, a condition imposed by a contract, or a corporate article.

16. The system of claim 13, wherein:
the network system is to monitor network traffic data, and wherein the compliance control system is to process the network traffic data to detect a data privacy violation;
the network system is to monitor network events to obtain network event data, and wherein the compliance control system is to process the network event data;
the network system is to obtain network security data, and wherein the compliance control system is to process the network security data to detect a network security violation; or
the network system is to obtain service level agreement (SLA) compliance data, and wherein the compliance control system is to process the SLA compliance data to detect an SLA violation.

17. The system of claim 13, wherein:
the compliance control system is to receive a definition of the compliance control policy at a policy definition component, and is to store the compliance control policy within a policy repository at an application level;
the compliance control system is to communicate the compliance control policy from the compliance control system to the network system, the network system being to utilize the compliance control policy in the obtaining of the network data;
the network system is to translate the compliance control policy into at least one network control policy, and is further to propagate the at least one network policy to at least one network service application;
the at least one network service application is to obtain the network data from a plurality of network entities, and is to aggregate to the network data; and
the at least one network service application is to filter the network data obtained from the plurality of network entities, the plurality network entities including at least one of a group consisting of network devices, network applications, and network Web services.

18. The system of claim 13, wherein the compliance control system is to perform process control responsive to the detection of violation of the compliance control policy of the entity, the process control including at least one of preventing prevent occurrence of an event or performing a remedial action to remedy the violation of the compliance control policy.

19. A system comprising:
first means for obtaining network data; and
second means for processing the network data to detect violation of a compliance control policy of an entity.

20. The system of claim 19, wherein the second means is for obtaining the application data, and is for processing the application data in conjunction with the network data to detect violation of the compliance control policy of the entity.

21. The system of claim 19, wherein the second means is for:
receiving a definition of the compliance control policy at a policy definition component, and is for storing the compliance control policy within a policy repository;
performing process control responsive to the detection of the violation of the compliance; and
performing access control responsive to the detection of the violation of the compliance control policy of the entity.

22. The system of claim 19, wherein at least one of the first means and the second means is to perform a notification action responsive to the detection of violation of the compliance control policy of the entity.

23. A machine-readable medium embodying instructions that, when executed by a machine, cause the machine to:
automatically obtain network data; and
automatically process the network data to detect violation of a compliance control policy of an entity.

24. The machine-readable medium of claim 23, wherein the instructions cause the machine to automatically obtain application data, and automatically to process the application data in conjunction with the network data to detect violation of the compliance control policy of the entity.
